(19) United States
(12) Patent Application Publication
(10) Pub. No.: US 2020/0364009 A1
(43) Pub. Date: Nov. 19, 2020

(54) DISTRIBUTING STATUSES

(71) Applicant: HEWLETT-PACKARD DEVELOPMENT COMPANY, L.P., Spring, TX (US)

(72) Inventor: Francisco Costa Majo, Sant Cugat del Valles (ES)

(73) Assignee: HEWLETT-PACKARD DEVELOPMENT COMPANY, L.P., Spring, TX (US)

(21) Appl. No.: 16/762,236

(22) PCT Filed: Nov. 30, 2017
(86) PCT No.: PCT/US2017/063927

§ 371 Date: May 7, 2020

(51) Int. Cl. G06F 3/12; H04L 29/08

(52) U.S. Cl. CPC G06F 3/1231; G06F 3/121; G06F 3/1236; H04L 67/16

(57) ABSTRACT

A method for distributing a status of a subsystem of a rendering apparatus, the method comprises maintaining a list of subscribed clients of the rendering apparatus at a first client of the rendering apparatus, and receiving, at a second client of the rendering apparatus, data relating to a subsystem of the rendering apparatus from the first client.

### BACKGROUND

A rendering apparatus, such as a printer (2D or 3D) for example, comprises multiple subsystems that can be monitored in order to determine the current status of a subsystem and the apparatus as a whole. For example, a material deposition subsystem, which relates to a material deposition arrangement of the apparatus, can provide information relating to the current levels in a material deposition repository or reservoir. A client of the apparatus can periodically poll the apparatus in order to update its knowledge of the multiple subsystems.

### BRIEF DESCRIPTION OF THE DRAWINGS

Various features of certain examples will be apparent from the detailed description which follows, taken in conjunction with the accompanying drawings, which together illustrate, by way of example only, a number of features, wherein:

FIG. 1 is a schematic representation of a system according to an example;

FIG. 2 is a schematic representation of a system according to an example;

FIG. 3 is a flowchart of a method according to an example;

FIG. 4 is a flowchart of a method according to an example;

FIG. 5 is a flowchart of a method according to an example; and

FIG. 6 is an example of a processor associated with a memory according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

A rendering apparatus, acting as a host, can be periodically polled by client devices that are connected to or using the apparatus in order for them to determine the current status of one or more of the apparatus subsystems. For example, a client can poll the apparatus to determine the current status of a print medium supply or a supply of deposition material, such as a print fluid or rendering material. In this way, connected clients can obtain information relevant to tasks that they may wish to perform, such as generating a 2D or 3D item.

Since current host-client communication systems operate such that the host is periodically polled, clients do not have a real-time status of the host apparatus. Furthermore, each client opens a TCP port on the host in order to enable the communication, which can place a strain on the host.

In an example, a rendering apparatus can be printing device, such as a 2D or 3D printer. Accordingly, subsystems of such printing devices can relate to such aspects as a supply of rendering material, such as a print fluid for example, a supply of print media (e.g. paper), the number of items rendered or printed and so on.

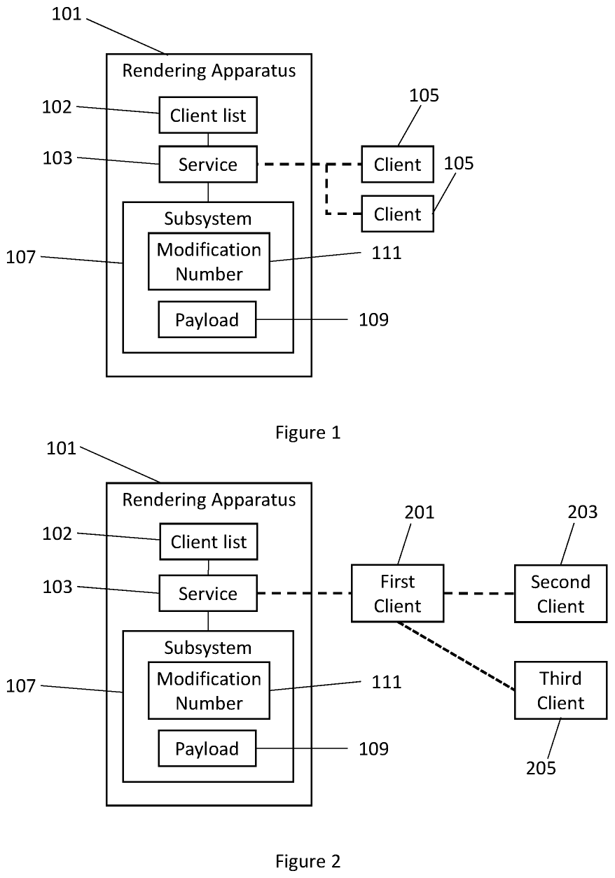

FIG. 1 is a schematic representation of a system according to an example. A service 103 of a rendering apparatus 101 can be used by a client 105 to query a status of the apparatus 101. More particularly, the service 103 can be used to determine the status of one or more subsystems 107 of the apparatus 101. In an example, each subsystem 107 comprises a payload 109 and a modification number 111, and represents a component or element of the rendering apparatus. In an example, the service 103 can comprise a set of instructions executing on a processor of the rendering apparatus 101 that enables retrieval of information from the rendering apparatus 101 by a client. In this context, a client can include user equipment, such as a computer or mobile device that can use the rendering apparatus 101 to generate an image or article.

Client 105 can use the service 103 to read all subsystem payload information of interest and store their modification numbers in a memory.

When the apparatus 101 modifies any of the subsystems 107, it can increment the modification number associated with that subsystem, which can be reflected in a change to a modification number provided by the service 103, thereby enabling the client 105 to determine that a change to a subsystem has occurred. Thus, the modification number provides a simple way to determine if a change has occurred to a subsystem, and the modification number provided by the service 103 for a subsystem may change when a subsystem modification number changes.

For example, the marked-up text below is an example of the data that can be returned by the service 103 in response to a query, and indicates the modification numbers of various subsystems of a rendering apparatus according to an example:

```
<Tree>
  <Name>PrintheadStatus</Name>
  <URI>/Services/PI/PrintheadStatus.xml</URI>
  <RootNode>ps:PrintheadStatus</RootNode>
  <ModificationNumber>121</ModificationNumber>
</Tree>
<Tree>
  <Name>InkSystem</Name>
  <URI>/Services/PI/InkSystem.xml</URI>
  <RootNode>is:InkSystem</RootNode>
  <ModificationNumber>562</ModificationNumber>
</Tree>
<Tree>
  <Name>PrinterMaintenance</Name>
  <URI>/Services/PI/PrinterMaintenance.xml</URI>
  <RootNode>pm:PrinterMaintenance</RootNode>
  <ModificationNumber>124</ModificationNumber>
</Tree>
```

Thus, as an example, the subsystem “InkSystem” can relate to one or more print fluids of a rendering apparatus, and the modification number for this subsystem at the time of query at the service 103 is 562. If this number is not the same as the modification number for this subsystem that the client currently has then the client may know that a change to this subsystem has occurred.

In an example, client 105 can poll the service every n seconds (e.g. every 5 seconds), and it can compare its stored modification numbers with current ones returned by the service 103 to enable it to fetch new payload data in the event of change. For example, client 105 can actively sample the status of the rendering apparatus 101 at predetermined intervals. Sampling can occur over a wired or wireless communication link established between the client and the rendering apparatus. In an example, client 105 can store a modification number in a memory thereof with an identifier that relates to the subsystem of the rendering apparatus that the modification number represents. A sampled modification number for the subsystem in question can be compared using a processor of the client with the stored value for that subsystem.

Thus, the client can compare the modification numbers of the subsystems provided by the service 103 with its stored values to determine, at a broad level, whether there has been a change in a subsystem of the apparatus. If the modification numbers are the same, no change has occurred. Conversely, if a modification number for a subsystem is not the same as the number stored at the client, the client can determine that a change to the subsystem has occurred. Accordingly, the payload data 109 for the modified subsystem in question can be retrieved. Regardless, the status at the client is not up to date as there may be a delay between a change to a subsystem of the apparatus and the client updating its records of at least n seconds. Furthermore, computational resources of the apparatus can become strained when multiple clients poll the service 103 in order to obtain up to date status information.

An example of a portion of payload data for the “InkSystem” subsystem is as follows:

```
<InkSlot>
  <Color>magenta</Color>
  <SlotId>3</SlotId>
  <InkAgentType>marking</InkAgentType>
  <SlotTubeId>3</SlotTubeId>
  <SlotGroupId>3</SlotGroupId>
  <SlotInfo>
    <InkSupplyInfo>
      <Status>
        <StatusFlag>Expired</StatusFlag>
      </Status>
      <State>Empty</State>
      <DetailedStatus>
        <StatusFlag>Unknown</StatusFlag>
      </DetailedStatus>
      <Capacity>
        <Value>775</Value>
        <Unit>cc</Unit>
      </Capacity>
      <Level>
        <Value>0</Value>
        <Unit>cc</Unit>
      </Level>
      <LevelPercentage>0.000000</LevelPercentage>
</InkSlot>
```

As can be seen, the payload information (of which this is just a small snapshot) comprises a finely grained level of detail about apparatus subsystems.

Thus, as can be seen from the above, the service 103 can be queried for a coarsely grained subsystem snapshot that provides modification numbers for subsystems of the apparatus. Upon comparison, if a modification number does not accord with that stored at a client, payload data can be retrieved from the service for the subsystem in question.

According to an example, each time a client 105 polls the apparatus 101 in order to query service 103, information representing the identity of the client 105 can be stored in a list of subscribed clients 102 of the apparatus 101. The apparatus 101, therefore, has a list of clients that may potentially poll it for status information.

FIG. 2 is a schematic representation of a system according to an example. In common with the system of FIG. 1, a service 103 of a rendering apparatus 101 can be used to query a status of the apparatus 101, and more particularly one or more subsystems 107 of the apparatus 101, each of which comprises a payload 109 and an associated modification number 111.

According to an example, a first client 201 can query the service 103. The first client 201 can receive data representing the current status of the subsystems of the apparatus, such as subsystem 107 for example. The first client 201 also receives data representing the list of subscribed clients 102 and the modification numbers of the subsystems of the apparatus. The list can be an index of subscribed clients or may be in the form of an array or marked-up data structure for example. In an example, the first client 201 can maintain a copy of the list of subscribed clients 102. In this way, the first client 201 has information representing all of the other clients that are connected to or otherwise using the apparatus 101, and takes on the role of a host client manager.

According to an example, a second client 203 of the rendering apparatus 101 can receive data relating to a subsystem 107 of the rendering apparatus 101 from the first client 201 instead of from the service 103. That is, the first client 101 can distribute a status and/or payload data of a subsystem 107 of the rendering apparatus 101 to other clients of the apparatus 101, thereby meaning that the other clients do not have to poll the service 103 directly. In this way, the other clients can receive up to date subsystem information quickly without overloading the apparatus 101 with multiple requests. Note that, although a second client 203 is depicted in FIG. 2, it may be appreciated that multiple clients can receive data from the first client 201. In an example, each client in the list of subscribed clients, a copy of which is maintained by the first client 201, can receive data from the first client 201 instead of from the service 103. As noted above, the data can relate to a payload of a subsystem of the apparatus that has changed.

According to an example, when the first client 201 connects to the apparatus 101 for the first time, the service 103 can provide an overview of the subsystem modification numbers, as depicted above. Each time an aspect or parameter of one of the subsystems 107 of the apparatus 101 changes, its modification number 111 as well as the modification number associated with that subsystem in the overview provided by the service 103 changes. For example, the modification numbers can be incremented. A connection between a client and the apparatus 101 can be a wired or wireless connection. For example, the connection can be made over a network, such as the internet, a local area network, a wide area network or a personal area network, and may use wireless or ethernet technology or a short-range radio frequency communication protocol.

In an example, when the first client 201 connects to the apparatus 101 for the first time it may query the apparatus 101 using long polling, which is a variation of traditional polling that enables a client to request information from a host as in normal polling but with the expectation the server may not respond immediately.

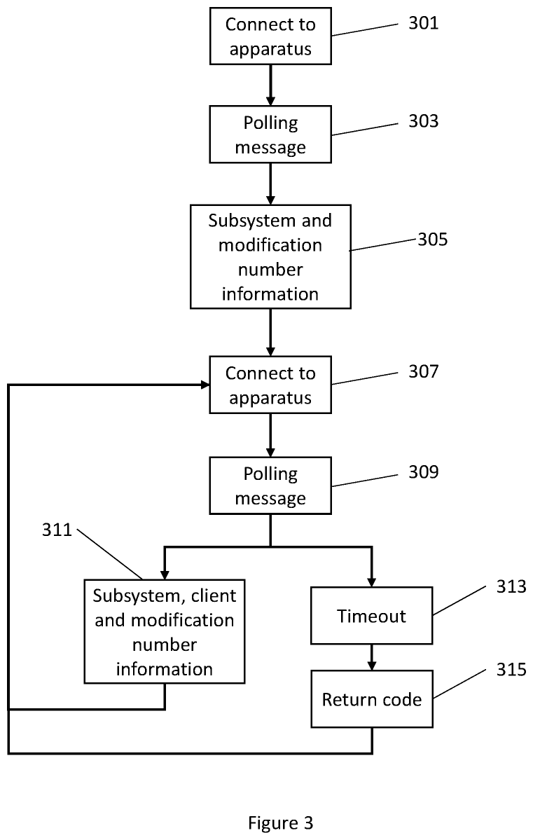

FIG. 3 is a flowchart of a method according to an example. In block 301, first client 201 connects to apparatus 101 by polling service 103 with a polling message 303. The message 303 can include parameters to indicate that long polling is set to true (i.e. that this is a long polling message) and that the modification number of the service 103 (mod_number) the first client has stored is −1. In an example, this value for the modification number can indicate that it is either not set or is unknown at the first client (since this is the very first time that the client has connected to the apparatus 101 and so it is unaware of any data relating to its subsystems).

Accordingly, for an apparatus 101 with a known location on a network, such that it has an IP address that is known to the first client 201 for example, the message 303 can be of the form:
http://<IP>/discovery.xml?longpolling=true&mod_number=−1

As the modification number is −1, the server 103 replies to the first client 201 in block 305 with a message, such as an XML message, with all published subsystem information including the subsystem modification numbers and a modification number of the service 103, which can be a modification number that can change in the even that any of the subsystem modification numbers change or that can be used to provoke certain actions by clients, as will be described in more detail below. That is, the apparatus 101 replies to the first client 201 with data that includes payload information and modification numbers for all subsystems (and the service) of the apparatus 101.

At a subsequent time, in block 307, the first client 201 connects to the apparatus 101 again. This time, the first client 201 queries the apparatus using a message in block 309 with parameters: long polling set to true and mod_number equal to the last known value of the modification number for the service 103:
http://<IP>/discovery.xml?longpolling=true&mod_number=XXX

If the service 103 has a modification number that is different than XXX, it replies, in block 311, with a message comprising all of the published subsystem information of the apparatus 101 comprising their modification numbers and the modification number of the service. In an example, the service 103 can reply with a message comprising the published (payload) information of the subsystem that has changed or with the payload information of all subsystems, along with the modification numbers and the modification number of the service. In addition, in an example, the message includes the IP/hostname addresses of all the other clients connected to the apparatus so that the first client 201 can maintain a copy of the list of subscribed clients.

In block 313, if the service 103 has a modification number equal to XXX, it does not reply until a timeout or new data of any subsystem is available before the timeout occurs (e.g. when some apparatus data has changed such as a roll of print media being changed or a new print fluid reservoir being installed and so on).

In an example, if the server 103 times-out it can return a specific code to the first client 201 in block 315 that causes the first client 201 to launch another long polling query to the service 103. This can be done by having two threads querying the apparatus 101, one that is waiting for a response to the message in block 309 and the other one that is prepared to launch a new query when the other request times out.

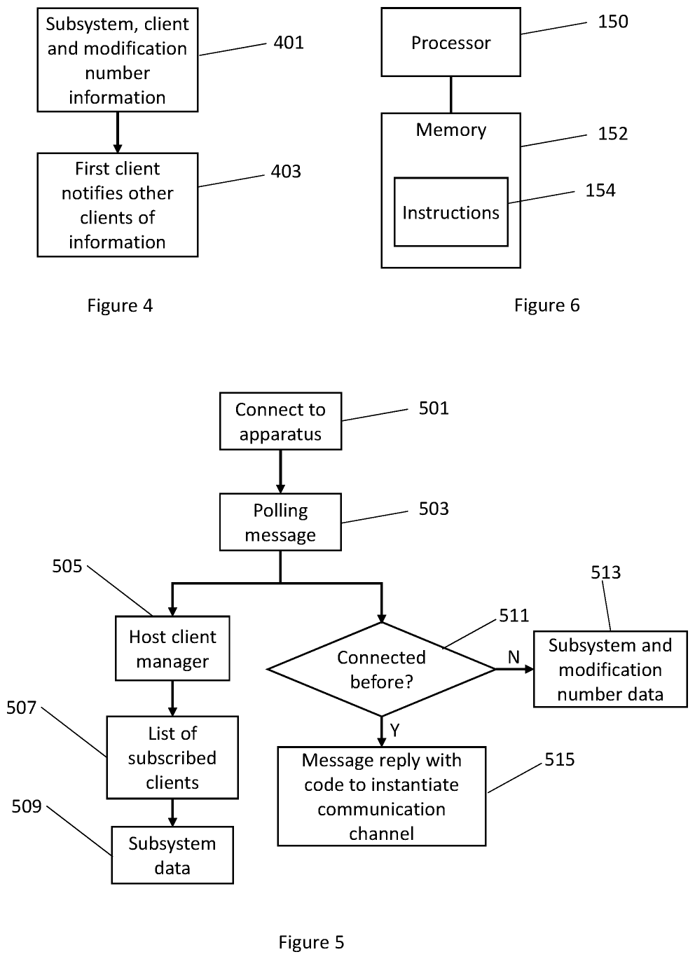

FIG. 4 is a flowchart of a method according to an example. In block 401, the first client 201 receives subsystem, client and modification number information from the apparatus 101 (as in block 311 of FIG. 3). In block 403, the first client 201 notifies all other clients of the apparatus reported by the service 103 of the subsystem and modification number information. That is, the first client 201 uses the data received from the service 103 representing the IP/hostname addresses of all the other clients connected to the apparatus 101 to transmit payload information for a subsystem that it has received from the service 103 to those clients.

In an example, the first client 201 can notify all other clients (such as client 203 for example) using a serialized UDP message with a snapshot of all current dynamic data from the apparatus 101. The messages can be serialized binary data that can be used to reconstruct a whole apparatus status object based on its binary API. In an example, a library such as SEREAL can be used for this purpose. In an example, a communications channel can be provided between the first client 201 and other clients of the system in order to enable the first client 201 to distribute up to date subsystem information. As will be explained below in more detail, the communications channel can utilise the UDP protocol, with each of the first client and other client of the system comprising a UDP server to facilitate the communications.

According to an example, in the event that the first client 201 wants to close the connection with the apparatus 101, it can select another client in the list of subscribed clients as the client used to maintain the list of subscribed clients and transmit data relating to apparatus 101 to those clients. That is, the first client 201 selects its successor, and notifies both the apparatus 101 and the chosen successor client. Therefore, in an example, the first client 201 selects a third client 205 from the list of subscribed clients and cedes maintenance of the subscribed list to the third client.

In an example, the chosen (third) client can thus stop its UDP server and start the two threads to query the apparatus using the long polling technique as described above. If there are no clients in the list the first client 201 can notify the apparatus in order to reset its status to #1.

Accordingly, by having one client that is used to distribute status information for the apparatus to other clients, the server 103 uses a single communication thread compared to the situation in which each client of the system opens a thread to the apparatus. The service 103 replies to the first client 201 with status information, and the rest of clients 203 are provided with this status information via the first client. In this way, the first client 201 therefore acts as a host client manager. Accordingly, clients can receive the current status of the apparatus directly from the first client 201.

In an example, when a second client 203 connects to the apparatus 101 for the first time it can query the apparatus with parameters: long polling set to true and mod_number equals −1, as described above:
http://<IP>/discovery.xml?longpolling=true&mod_number=−1

Again, as the modification number is −1 (meaning not set or unknown), the server 103 can reply with all published subsystem information and modification numbers and the modification number of the service 103. The apparatus 101 stores the IP address or hostname of this client 203 and can report to it to the first client 201 as part of the message provided in block 311 (FIG. 3).

Thus, when the second client 203 subsequently connects to the apparatus 101 it can query the apparatus 101 with parameters: long polling set to true and mod_number equal to the last known one (of the service 103):
http://<IP>/discovery/xml?longpolling=true&mod_number=XXX

The service 103, knowing that the second client 203 is not the first client that has connected can reply with a special code for the mod_number, such as 999 for example. The code can instruct the second client 203 to start a UDP server listening for new snapshot notifications coming from the first client 201. In an example, the second client 203 keeps querying the apparatus 101 periodically (e.g. once every minute) in order to keep it in the list of subscribed clients in the apparatus. In this way, since the first client 201 maintains a copy of the list of subscribed clients, the second client 203 may receive notifications with updated apparatus snapshots coming from the first client 201. That is, as long as the second client 203 maintains itself in the list of subscribed clients by querying apparatus 101, it may be maintained in the copy of the list stored at the first client 201 and may, therefore, receive status updates form the first client 201.

The server 103 can remove the second client 203 from its list of subscribed clients if it does not receive any queries from it for a predetermined period of time, such as more than a minute for example, in which case it also falls off the list at the first client and may no longer receive updates.

FIG. 5 is a flowchart of a method according to an example. In block 501 a client connects to service 103 of apparatus 101 with a long polling message 503. In block 505, if the client is the first client to connect to the apparatus it becomes the host client manager. That is, it may be the first client 201 that maintains a copy of the list of subscribed clients (block 507) and distributes data (including modification numbers) relating to a subsystem of the apparatus to other clients (block 509) in the list. As described above, this means that the first client can be used to distribute data to multiple other clients without them having to open TCP threads to the apparatus 101.

If the client is not the first client to connect to the apparatus there are, according to an example, two possibilities (block 511), as described above—firstly, the client in question has connected to the apparatus before, or it has not. If it has not, the service 103 of the apparatus 101 replies, in block 513, to its connection message 503 with all published subsystem information and modification numbers and the modification number of the service 103. As noted above, the apparatus 101 stores the IP address or hostname of this client. On a subsequent connection attempt, the process for this client may pick up from block 515, as described in more detail below. The IP address or hostname of this client can be provided to the host client manager as part of the information provided to it by the apparatus 101 so that it can maintain an up to date copy of the list of subscribed clients.

According to an example, in block 515, in the event that the client has previously connected to the apparatus 101, but it is not the first client to do so (i.e. there already exists a host client manager), a connection message (block 503) to service 103 from the client may result in return of a message with a code (e.g. 555 as described above) provoking instantiation of a communication channel between the client and the host client manager. As described above, the communication channel can use a UDP protocol between the client and the host client manager, e.g. between the first and second clients of FIG. 2 for example, in order to enable the first client 201 to distribute data representing modification numbers and subsystem information to the second client 203.

According to an example, when the first client 201 (i.e. the host client manager) polls the service 103, and the modification number of the service 103 is different to the one it currently has, the first client 201 can then determine which subsystem of the apparatus has changed by checking the modification numbers of the subsystems. Once determined, the payload data for the modified subsystem can be downloaded by the first client, which can then be distributed to other clients in the list of subscribed clients. Thus, the first client does not have to download the entire tree of subsystem related information for the apparatus, and the apparatus does not become overloaded with requests from multiple clients.

Although one subsystem 107 is depicted in FIG. 2, it will be appreciated that the apparatus comprises multiple subsystems, and that the service can be used to download payload and modification number data from any number of such subsystems.

Examples in the present disclosure can be provided as methods, systems or machine-readable instructions. Such machine-readable instructions may be stored on a non-transitory machine-readable or computer-readable storage medium. The storage medium can include one or multiple different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices.

In an example, a client and a rendering apparatus can communicate with one another using a network, such that the client and rendering apparatus form network nodes that can exchange data with each other using a data link. The connections between nodes can be established using either wired or wireless links, and various technologies may be used such as ethernet or wireless local area networking (e.g. Wi-Fi).

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be used and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing apparatus may execute the machine-readable instructions. Thus, modules of apparatus (for example, rendering apparatus 101) may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode.

For example, the instructions may be provided on a non-transitory computer readable storage medium encoded with instructions, executable by a processor.

FIG. 6 shows an example of a processor 150 associated with a memory 152 according to an example. The memory 152 comprises computer readable instructions 154 which are executable by the processor 150. In an example, the instructions 154 comprise instructions to:

poll the rendering apparatus 101 to determine a modification to a first subsystem 107 thereof;

download data from the rendering apparatus 101 representing a payload 109 of the first subsystem 107; and

transmit the data to respective ones of multiple clients 203 subscribed to the rendering apparatus 101.

Such machine-readable instructions may also be loaded onto a computer or other programmable data processing devices, so that the computer or other programmable data processing devices perform a series of operations to produce computer-implemented processing, thus the instructions executed on the computer or other programmable devices provide a operation for realizing functions specified by flow(s) in the flow charts and/or block(s) in the block diagrams.

While the method, apparatus and related aspects have been described with reference to certain examples, various modifications, changes, omissions, and substitutions can be made without departing from the spirit of the present disclosure. In particular, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method for distributing a status of a subsystem of a rendering apparatus, the method comprising:
maintaining a list of subscribed clients of the rendering apparatus at a first client of the rendering apparatus; and
receiving, at a second client of the rendering apparatus, data relating to a subsystem of the rendering apparatus from the first client.

2. A method as claimed in claim 1, further comprising:
monitoring, using the first client, a discovery service of the rendering apparatus.

3. A method as claimed in claim 2, further comprising:
determining a change in the subsystem of the rendering apparatus; and
receiving, at the first client, payload data for the subsystem.

4. A method as claimed in claim 3, further comprising:
transmitting the payload data for the subsystem from the first client to the second client.

5. A method as claimed in claim 1, further comprising:
receiving the list of subscribed clients from the rendering apparatus.

6. A method as claimed in claim 1, further comprising:
transmitting data relating to the subsystem of the rendering apparatus from the first client to the list of subscribed clients.

7. A method as claimed in claim 1, further comprising:
instantiating a communication channel between the first and second clients.

8. A method as claimed in claim 7, further comprising:
polling, using the second client, the rendering apparatus;
receiving, at the second client, a message from the rendering apparatus; and
instantiating the communications channel on the basis of the content of the message.

9. A method as claimed in claim 1, further comprising:
selecting, using the first client, a third client from the list of subscribed clients; and
ceding maintenance of the subscribed list to the third client.

10. A system, comprising:
a rendering apparatus comprising multiple subsystems;
a first client to maintain a list of subscribed clients of and received from the rendering apparatus; and
a second client to receive data relating to a first subsystem of the rendering apparatus from the first client.

11. A system as claimed in claim 10, the first client further to:
poll the rendering apparatus to determine a modification to a subsystem status; and
transmit payload data for a modified subsystem to the second client.

12. A system as claimed in claim 10, the rendering apparatus to:
transmit a message to a third client, the third client to instantiate a communications channel to the first client on the basis of the content of the message.

13. A system as claimed in claim 10, the first client further to:
transmit data relating to a subsystem of the rendering apparatus from the first client to the list of subscribed clients.

14. A system as claimed in claim 10, the first client further to;
monitor a service of the rendering apparatus;
determine a change to a subsystem of the rendering apparatus;
download payload data from the rendering apparatus for that subsystem; and
transmit the payload data to the list of subscribed clients.

15. A non-transitory machine-readable storage medium encoded with instructions executable by a processor of a client device for determining a status of a subsystem of a rendering apparatus, the machine-readable storage medium comprising instructions to:
poll the rendering apparatus to determine a modification to a first subsystem thereof;
download data from the rendering apparatus representing a payload of the first subsystem; and
transmit the data to respective ones of multiple clients subscribed to the rendering apparatus.
